(19) United States
(12) Patent Application Publication
(10) Pub. No.: US 2015/0330058 A1
(43) Pub. Date: Nov. 19, 2015

(54) METHOD FOR CONTROLLING HYDRAULIC SYSTEM FOR CONSTRUCTION MACHINE

(71) Applicant: Sang-Hee LEE, Changwon-si (KR)

(72) Inventor: Sang-Hee LEE, Changwon-si (KR)

(73) Assignee: VOLVO CONSTRUCTION EQUIPMENT AB, Eskilstuna (SE)

(21) Appl. No.: 14/410,987

(22) PCT Filed: Jul. 16, 2012
(86) PCT No.: PCT/KR2012/005652

§ 371 Date: Dec. 23, 2014

(51) Int. Cl. E02F 9/22; F15B 11/16; E02F 9/20

(52) U.S. Cl. CPC E02F 9/2242; E02F 9/2285; E02F 9/2004; E02F 9/2292; E02F 9/2296; E02F 9/2235; F15B 11/166

(57) ABSTRACT

A method for controlling a hydraulic system for a construction machine is disclosed, which can minimize a loss of pressure through expansion of an open area of a confluence spool in the case of singly driving a working device such as a boom. The method for controlling a hydraulic system includes a first step of detecting pilot signals according to operations of operation levers for first and second working devices through first and second pressure sensing devices and transmitting the detected pilot signals to the controller; a second step of determining whether the operation is a single operation of the operation lever for the first working device; a third step of supplying secondary signal pressure by an electro-proportional value to the confluence spool to expand an open area of the confluence spool with respect to the same operation pressure of the operation lever for the first working device and discharging hydraulic fluid discharged from a second hydraulic pump in proportion to the operation amount of the operation lever for the first working device if the operation lever for the first working device is operated to exceed a determined section in the case of singly driving the first working device due to the single operation of the operation lever for the first working device; and a fourth step of supplying the secondary signal pressure by the electro-proportional value to the confluence spool in proportion to the operation amount of the operation lever for the first working device and dividedly supplying the hydraulic fluid discharged from the second hydraulic pump to the first and second working devices in the case of performing a combined driving of the first and second working devices due to simultaneous operations of the operation levers for the first and second working devices.

### TECHNICAL FIELD

The present invention relates to a method for controlling a hydraulic system for a construction machine. More particularly, the present invention relates to a method for controlling a hydraulic system for a construction machine is disclosed, which can minimize a loss of pressure through expansion of an open area of a confluence spool in the case of singly driving a working device such as a boom in the hydraulic system provided with a plurality of hydraulic pumps and the confluence spool.

### BACKGROUND ART

A hydraulic system for a construction machine to which the present invention is applied, as illustrated in FIG. 1, includes an engine 1; first and second variable displacement hydraulic pumps (hereinafter referred to as a “first and second hydraulic pumps”) 2 and 3 connected to the engine 1 and a pilot pump 4; a first working device (not illustrated), such as a boom, connected to the first hydraulic pump 2 through a discharge flow path 2a to be driven when hydraulic fluid is supplied thereto; a second working device (not illustrated), such as an arm, connected to the second hydraulic pump 3 through a discharge flow path 3a to be driven when hydraulic fluid is supplied thereto; an operation lever (RCV) 5 for the first working device outputting an operation signal that corresponds to an operation amount by an operator; an operation lever (RCV) 6 for the second working device outputting an operation signal that corresponds to an operation amount by the operator; a main control valve provided with spools 7 and 8 for the first and second working devices shifted by the operations of the operation levers 5 and 6 for the first and second working devices to control the hydraulic fluid supplied from the first and second hydraulic pumps 2 and 3 to the first and second working devices, and a confluence spool 9 shifted by the operation of the operation lever 5 for the first working device to make the hydraulic fluid of the second hydraulic pump 3 and the hydraulic fluid of the first hydraulic pump 2 join together; a controller 11; a first pressure sensing device 12 detecting the operation signal of the operation lever 5 for the first working device and transmitting a detected pilot signal to the controller 11; a second pressure sensing device 13 detecting the operation signal of the operation lever 6 for the second working device and transmitting a detected pilot signal to the controller 11; and an electro-proportional valve 14 converting pilot signal pressure that is supplied from the pilot pump 4 to the confluence spool 9 into secondary signal pressure corresponding to a control signal from the controller 11.

In the drawing, the unexplained reference numeral 20 denotes a graph of a control diagram of the second hydraulic pump 3 during a combined operation of the operation lever 5 for the first working device and the operation lever 6 for the second working device.

In the hydraulic system for a construction machine as configured above, if an operator operates the operation lever 5 for the first working device for boom-up operation, pilot signal pressure that is discharged from the pilot pump 4 is supplied to the spool 7 for the first working device to shift the spool 7 in a rightward direction in the drawing. In this case, the pilot signal pressure that is detected by the first pressure sensing device 12 is transmitted to the controller 11.

Through this, the hydraulic fluid that is discharged from the first hydraulic pump 2 to correspond to the operation amount of the operation lever 5 for the first working device is supplied to the boom cylinder (not illustrated) via the discharge flow path 2a, the spool 7 for the first working device, and a flow path 15 in order.

In this case, if the operator increases the stroke of the operation lever 5 for the first working device for faster boom-up operation of the boom cylinder, the controller 11 outputs a control signal for controlling the electro-proportional valve 14. As shown in a control diagram 17 of FIG. 2 to control a shift amount of the confluence spool 9, the confluence spool 9 is shifted in the leftward direction in FIG. 1 by the pilot signal pressure that is supplied from the pilot pump 4. That is, if the operation amount of the operation lever 5 for the first working device is “a1”, the secondary signal pressure as high as “b1” is supplied to the confluence spool 9 in proportion to “a1”, while if the operation amount is “a2”, the secondary signal pressure as high as “b2” is supplied to the confluence spool 9 in proportion to “a2”.

Through this, as shown in a control diagram 18 of FIG. 2, the second hydraulic pump 3 discharges the hydraulic fluid that is in proportion to the operation amount of the operation lever 5 for the first working device. That is, if the operation amount of the operation lever 5 for the first working device is “c1”, the second hydraulic pump 3 discharges the hydraulic fluid as much as “d1” in proportion to “c1”, while if the operation amount is “c2”, the second hydraulic pump 3 discharges the hydraulic fluid as much as “d2” in proportion to “c2”. Through this, the hydraulic fluid that is discharged from the second hydraulic pump 3 passes through the discharge flow path 3a, the confluence spool 9, and a confluence flow path 16 in order, and then joins the hydraulic fluid that is discharged from the first hydraulic pump 2 to the flow path 15.

On the other hand, the control diagram 17 illustrated in FIG. 2 to control the confluence spool 9 is equally applied to not only single driving of a boom-up operation but also a combined operation of working devices, such as a boom and an arm, through shifting of the spool 8 for the second working device.

In the case of singly performing the boom-up operation, the other working device (such as the arm) does not use the hydraulic fluid of the first and second hydraulic pumps 2 and 3, and thus the hydraulic fluid that is discharged from the first and second hydraulic pumps 2 and 3 is used only for the boom-up operation. That is, in the case of singly performing the boom-up operation, the hydraulic fluid that is supplied to the boom cylinder can be controlled only by the control of the first and second hydraulic pump 2 and 3. Accordingly, in the case of the single boom-up operation, an open area of the confluence spool 9 is controlled to become small, and thus the control that causes a loss of pressure in the confluence spool 9 becomes unnecessary.

That is, according to the method for controlling a hydraulic system for a construction machine in the related art, since the open area of the confluence spool 9 is controlled to become small during the single boom-up operation, unnecessary pressure loss occurs due to metering of the confluence spool 9, and this causes a loss of the fuel efficiency of the equipment.

### DISCLOSURE

### Technical Problem

Therefore, the present invention has been made to solve the above-mentioned problems occurring in the related art, and one embodiment of the present invention is related to a method for controlling a hydraulic system for a construction machine, which can heighten the fuel efficiency by minimizing a loss of pressure that is generated in a confluence spool through expansion of an open area of the confluence spool in the case of singly driving a working device such as a boom rather than in the case of a combined operation of working devices.

### Technical Solution

In accordance with an aspect of the present invention, there is provided a method for controlling a hydraulic system for a construction machine including first and second hydraulic pumps connected to an engine, a pilot pump, first and second working devices connected to the first and second hydraulic pumps to be driven, operation levers for the first and second working devices outputting operation signals that correspond to the operation amounts, spools for the first and second work devices shifted by operations of the operation levers for the first and second working devices to control hydraulic fluid supplied to the first and second working devices, a main control valve having a confluence spool that makes hydraulic fluid of the second hydraulic pump and hydraulic fluid of the first hydraulic pump join together, a controller, first and second pressure sensing devices detecting operation signals of the operation levers for the first and second working devices, and an electro-proportional valve converting pilot signal pressure that is supplied to the confluence spool into secondary signal pressure corresponding to a control signal from the controller, the method includes a first step of detecting pilot signals according to the operations of the operation levers for the first and second working devices through the first and second pressure sensing devices and transmitting the detected pilot signals to the controller; a second step of determining whether the operation is a single operation of the operation lever for the first working device; a third step of supplying secondary signal pressure by the electro-proportional value to the confluence spool to expand an open area of the confluence spool with respect to the same operation pressure of the operation lever for the first working device and discharging hydraulic fluid discharged from the second hydraulic pump in proportion to the operation amount of the operation lever for the first working device if the operation lever for the first working device is operated to exceed a determined section in the case of singly driving the first working device due to the single operation of the operation lever for the first working device; and a fourth step of supplying the secondary signal pressure by the electro-proportional value to the confluence spool in proportion to the operation amount of the operation lever for the first working device and dividedly supplying the hydraulic fluid discharged from the second hydraulic pump to the first and second working devices in the case of performing a combined driving of the first and second working devices due to simultaneous operations of the operation levers for the first and second working devices.

Preferably, electronic operation levers may be used as the operation levers for the first and second working devices.

### Advantageous Effect

The method for controlling a hydraulic system for a construction machine according to the aspect of the present invention has the following advantages.

In the case of singly driving a working device, such as boom-up driving, the loss of pressure that is generated in the confluence spool can be minimized through expansion of the open area of the confluence spool in comparison to the case of the combined driving, and thus the fuel efficiency of the equipment can be heightened.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a hydraulic circuit diagram of a hydraulic system for a construction machine to which the present invention is applied;

FIG. 2 is a flowchart illustrating a method for controlling a hydraulic system for a construction machine in the related art;

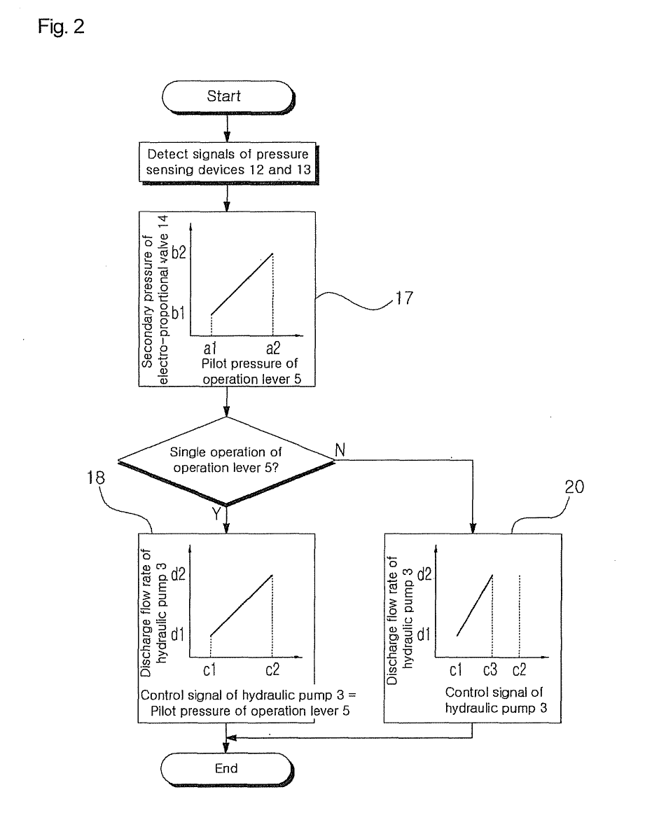

FIG. 3 is a flowchart illustrating a method for controlling a hydraulic system for a construction machine according to an embodiment of the present invention; and

FIG. 4 is a graph showing correlation between secondary pressure of an electro-proportional valve and an open area of a confluence valve in a method for controlling a hydraulic system for a construction machine according to an embodiment of the present invention.

### DESCRIPTION OF REFERENCE NUMERALS IN THE DRAWING

1: engine
2: first variable displacement hydraulic valve
3: second variable displacement hydraulic valve
4: pilot pump
5: operation lever for a first working device
6: operation lever for a second working device
7: spool for a first working device
8: spool for a second working device
9: confluence spool
10: main control valve (MCV)
11: controller
12: first pressure sensing device
13: second pressure sensing device
14: electro-proportional valve
15: flow path
16: confluence flow path

### BEST MODE

Hereinafter, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

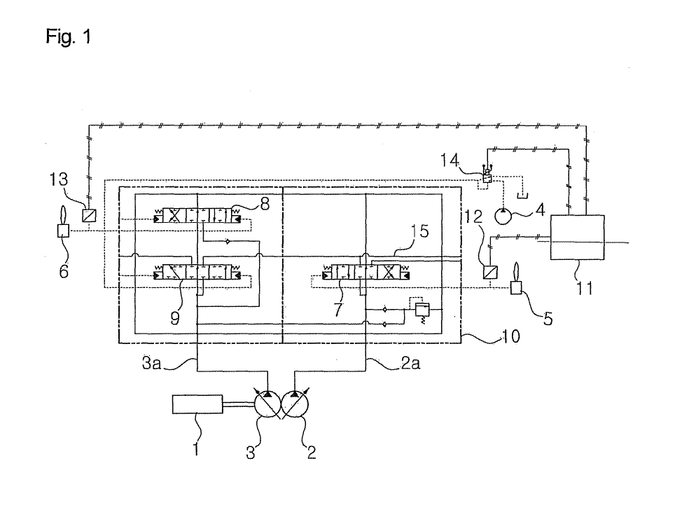

According to an embodiment of the present invention, referring to FIGS. 1, 3, and 4, a method for controlling a hydraulic system for a construction machine including an engine 1; first and second variable displacement hydraulic pumps (hereinafter referred to as a “first and second hydraulic pumps”) 2 and 3 connected to the engine 1 and a pilot pump 4; a first working device, such as a boom, connected to the first hydraulic pump 2 through a discharge flow path 2a to be driven when hydraulic fluid is supplied thereto; a second working device, such as an arm, connected to the second hydraulic pump 3 through a discharge flow path 3a to be driven when hydraulic fluid is supplied thereto; an operation lever 5 for the first working device outputting an operation signal that corresponds to an operation amount by an operator; an operation lever 6 for the second working device outputting an operation signal that corresponds to an operation amount by the operator; a main control valve provided with spools 7 and 8 for the first and second working devices shifted by the operations of the operation levers 5 and 6 for the first and second working devices to control the hydraulic fluid supplied from the first and second hydraulic pumps 2 and 3 to the first and second working devices, and a confluence spool 9 shifted by the operation of the operation lever 5 for the first working device to make the hydraulic fluid of the second hydraulic pump 3 and the hydraulic fluid of the first hydraulic pump 2 join together; a controller 11; a first pressure sensing device 12 detecting the operation signal of the operation lever 5 for the first working device and transmitting a detected pilot signal to the controller 11; a second pressure sensing device 13 detecting the operation signal of the operation lever 6 for the second working device and transmitting a detected pilot signal to the controller 11; and an electro-proportional valve 14 converting pilot signal pressure that is supplied from the pilot pump 4 to the confluence spool 9 into secondary signal pressure corresponding to a control signal from the controller 11, includes a first step (S100) of detecting pilot signals according to the operations of the operation levers 5 and 6 for the first and second working devices through the first and second pressure sensing devices 12 and 13 and transmitting the detected pilot signals to the controller 11; a second step (S200) of determining whether the operation is a single operation of the operation lever 5 for the first working device; a third step (S300: S300A and S300B) of supplying secondary signal pressure by the electro-proportional value 14 to the confluence spool 9 to expand an open area of the confluence spool 9 with respect to the same operation pressure of the operation lever 5 for the first working device and discharging hydraulic fluid discharged from the second hydraulic pump 3 in proportion to the operation amount of the operation lever 5 for the first working device if the operation lever 5 for the first working device is operated to exceed a determined section in the case of singly driving the first working device due to the single operation of the operation lever 5 for the first working device; and a fourth step (S400: S400A and S400B) of supplying the secondary signal pressure by the electro-proportional value 14 to the confluence spool 9 in proportion to the operation amount of the operation lever 5 for the first working device and dividedly supplying the hydraulic fluid discharged from the second hydraulic pump 3 to the first and second working devices in the case of performing a combined driving of the first and second working devices due to simultaneous operations of the operation levers 5 and 6 for the first and second working devices.

Preferably, electronic operation levers may be used as the operation levers 5 and 6 for the first and second working devices.

Hereinafter, a use example of the method for controlling a hydraulic system for a construction machine according to an embodiment of the present invention will be described in detail with reference to the accompanying drawings.

As shown in FIGS. 1, 3, and 4, if an operator operates the operation lever 5 for the first working device for boom-up operation, pilot signal pressure that is discharged from the pilot pump 4 is supplied to the spool 7 for the first working device to shift the spool 7 in a rightward direction in the drawing. In this case, the pilot signal pressure that is detected by the first pressure sensing device 12 is transmitted to the controller 11. Accordingly, the hydraulic fluid that is discharged from the first hydraulic pump 2 to correspond to the operation amount of the operation lever 5 for the first working device is supplied to the boom cylinder via the discharge flow path 2a, the spool 7 for the first working device, and a flow path 15 in order.

In this case, if the operator increases the stroke of the operation lever 5 for the first working device for faster boom-up operation of the boom cylinder, pilot signal pressure that is detected by the first pressure sensing device 12 is transmitted to the controller 11.

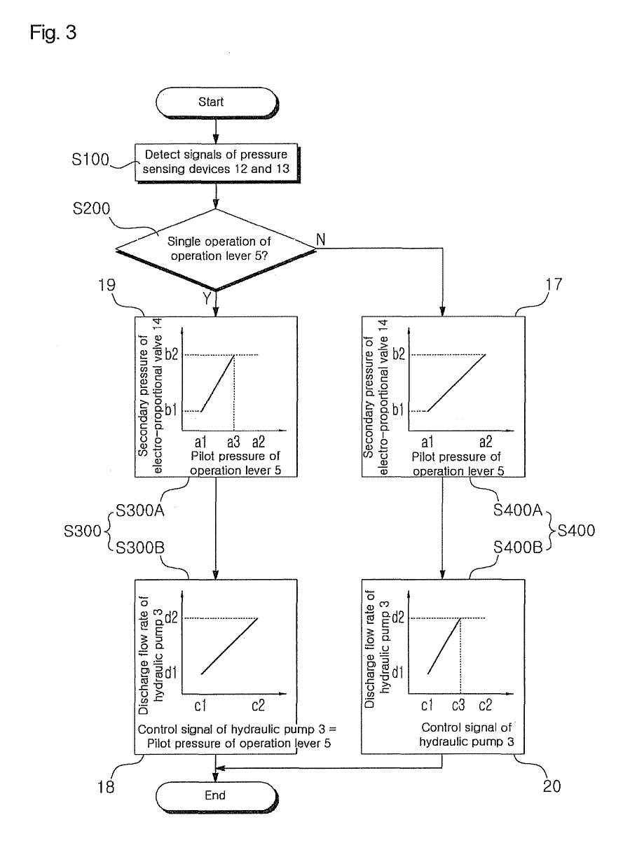

In this case, as shown in control diagrams 17 and 19 of FIG. 3 to control the electro-proportional valve 14, if the pilot signal pressure that is detected by the first pressure sensing device 12 is higher than pilot pressure a1 by the operation of the operation lever 5 for the first working device, the controller 11 controls the electro-proportional valve 14 as shown in a control diagram 19.

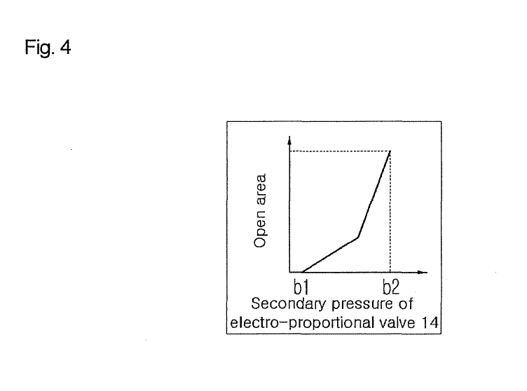

In this case, the difference between the control diagrams 17 and 19 is that the slope of the secondary pressure for controlling the electro-proportional valve 14 of the control diagram 19 becomes higher than the slope of the secondary pressure for controlling the electro-proportional valve 14 of the control diagram 17. Due to this, as shown in FIG. 4, a larger open area of the confluence spool 9 for the first working device is secured with respect to the same pilot pressure of the operation lever 5 for the first working device.

In this case, the hydraulic fluid that is discharged from the second hydraulic pump 3 as shown in the control diagram 18 of FIG. 3 becomes equal to the discharge amount when the operation lever 5 for the first working device is singly driven. That is, the loss of pressure in the confluence spool 9 for the first working device becomes smaller with respect to the same operation amount of the operation lever 5 for the first working device.

On the other hand, in the case of operating the operation lever 6 for the second working device, the pilot signal that is detected by the second pressure sensing device 13 is transmitted to the controller 11, and thus the controller 11 determines that a combined operation of the working devices is performed through simultaneous operation of the operation levers 5 and 6 for the first and second working devices.

Accordingly, the electro-proportional valve 14 is controlled by the control signal from the controller 11 as shown in the control diagram 17 of FIG. 3. In this case, the discharge flow rate of the second hydraulic pump 3 becomes the sum of the flow rates that are required by the first working device (e.g., boom cylinder) and the second working device (e.g., arm cylinder) as shown in the control diagram 20 of FIG. 3.

That is, since the hydraulic fluid discharged from the first and second hydraulic pumps 2 and 3 is distributed and supplied to the first and second working devices (this is the same as the hydraulic system that distributes and supplies the hydraulic fluid from the first and second hydraulic pumps to the first and second working devices during the combined operation in the related art), this does not interfere with the operation performance during the combined operation in the related art, and the fuel efficiency of the equipment can be improved only in the case of the single operation.

### INDUSTRIAL APPLICABILITY

As apparent from the above description, according to the present invention having the above-described configuration, a loss of pressure that is generated in a confluence spool can be minimized through expansion of an open area of the confluence spool in the case of singly driving a working device such as a boom rather than in the case of a combined operation of working devices.

1. A method for controlling a hydraulic system for a construction machine including first and second hydraulic pumps connected to an engine, a pilot pump, first and second working devices connected to the first and second hydraulic pumps to be driven, operation levers for the first and second working devices outputting operation signals that correspond to the operation amounts, spools for the first and second work devices shifted by operations of the operation levers for the first and second working devices to control hydraulic fluid supplied to the first and second working devices, a main control valve having a confluence spool that makes hydraulic fluid of the second hydraulic pump and hydraulic fluid of the first hydraulic pump join together, a controller, first and second pressure sensing devices detecting operation signals of the operation levers for the first and second working devices, and an electro-proportional valve converting pilot signal pressure that is supplied to the confluence spool into secondary signal pressure corresponding to a control signal from the controller, the method comprising:
a first step of detecting pilot signals according to the operations of the operation levers for the first and second working devices through the first and second pressure sensing devices and transmitting the detected pilot signals to the controller;
a second step of determining whether the operation is a single operation of the operation lever for the first working device;
a third step of supplying secondary signal pressure by the electro-proportional value to the confluence spool to expand an open area of the confluence spool with respect to the same operation pressure of the operation lever for the first working device and discharging hydraulic fluid discharged from the second hydraulic pump in proportion to the operation amount of the operation lever for the first working device if the operation lever for the first working device is operated to exceed a determined section in the case of singly driving the first working device due to the single operation of the operation lever for the first working device; and
a fourth step of supplying the secondary signal pressure by the electro-proportional value to the confluence spool in proportion to the operation amount of the operation lever for the first working device and dividedly supplying the hydraulic fluid discharged from the second hydraulic pump to the first and second working devices in the case of performing a combined driving of the first and second working devices due to simultaneous operations of the operation levers for the first and second working devices.

2. The method for controlling a hydraulic system according to claim 1, wherein electronic operation levers are used as the operation levers for the first and second working devices.
